(19) United States
(12) Patent Application Publication
(10) Pub. No.: US 2023/0391133 A1
(43) Pub. Date: Dec. 7, 2023

(54) CARD DEFECT CORRECTION TOOL

(71) Applicant: Kurt Thomas Colone, Clarkston, MI (US)

(72) Inventor: Kurt Thomas Colone, Clarkston, MI (US)

(21) Appl. No.: 18/170,303

(22) Filed: Feb. 16, 2023

Related U.S. Application Data
(60) Provisional application No. 63/348,221, filed on Jun. 2, 2022.

(51) Int. Cl. B44B 11/00

(52) U.S. Cl. CPC B44B 11/00; B44B 2700/12

(57) ABSTRACT

A collectible card defect correction tool has a cylindrical handle and a ductile, resilient tubing coupled to and extending from a first end of the handle. The handle has a first diameter over a first length. The tubing has an inner diameter. The card tool easily eliminates dents and bends on collectible cards, such as sports cards and gaming cards, making them more presentable and valuable. The handle is comfortable to use, like holding a paint brush.

### CROSS-REFERENCE TO RELATED APPLICATION

This application claims the benefit of priority of U.S. provisional application No. 63/348,221, filed Jun. 2, 2022, the contents of which are herein incorporated by reference.

### BACKGROUND OF THE INVENTION

The present invention relates to collectible cards and, more particularly, to a card defect correction tool.

Many collectors want their cards to be in perfect condition. The condition of the card significantly affects its value as a collectible. As such, it is very common for cards, as well as other collectible objects, to be professionally evaluated by industry recognized experts and graded to determine the value of a particular card or object. Grading cards is based on various characteristics that pertain to the “general eye appeal” of the card. Characteristics of the card that are universally examined in the grading process are centering, corners, edges, and surface. The corners of the card are inspected to determine the quality of the physical condition of the corner and/or if any defect of the corners is present. The edges of the card are examined, similarly as the corners, to determine the quality of the physical condition of the edges of the card, and account for any damages and/or imperfections along the edges. The surface of the card is examined to account for any damage and/or imperfections on the card, such as scratches, creases, tears, pinholes, stains, dents, attempts at recoloring, etc.

As can be seen, there is a need for a tool that can correct defects on a collectible card.

### SUMMARY OF THE INVENTION

In one aspect of the present invention, a collectible card defect correction tool comprises a cylindrical handle having a first diameter over a first length; and a ductile, resilient tubing coupled to a first end of the cylindrical handle and extending therefrom, the ductile, resilient tubing having an inner diameter.

The inventive tool easily eliminates dents and bends on collectible cards, such as sports cards and gaming cards, making them more presentable and valuable. The handle is comfortable to use, like holding a paint brush.

These and other features, aspects and advantages of the present invention will become better understood with reference to the following drawings, description, and claims.

### BRIEF DESCRIPTION OF THE DRAWINGS

FIG. 1 is a front perspective view of a tool to correct defects on collectible cards according to an embodiment of the present invention;

FIG. 2 is a detail exploded perspective view thereof;

FIG. 3 is a side elevation view thereof, shown in use;

FIG. 4 is an exploded elevation view thereof;

FIG. 5 is a side elevation view thereof, showing a step of a method of correcting a card defect according to an embodiment of the present invention; and

FIG. 6 is a side elevation view thereof, shown another step of the method.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a tool comprising a handle with a ductile, resilient tubular material affixed at one end, operative to smooth out and remove dents and dings on a card. The tool is sometimes referred to herein as “The Card Tool”.

To use the inventive tool, the user may hold The Card Tool like a pen or paintbrush. The tubing attached to the end of the handle may be used to remedy a trouble area on the surface of a card by gently rubbing the tool's tubing portion over a bump, dent, bend, or ding to move it back in place, eliminating the blemish. The method is easy and effective.

To manufacture a tool according to an embodiment of the present invention, without limiting the dimensions of the present invention, a 5.5″ section of a ⅜″ diameter wooden dowel may be reduced at one end for a length of ¾ inch to a 5/16″ diameter using a lathe. A 1.6″ length of 5/16″ to 7/16″ inner diameter vinyl tubing may be attached to the 10 mm end of the wooden dowel and adjusted to cover the ¾ ″ reduced portion of the dowel. When completed, the dowel serves as a handle and the cut section of tubing at the end is a smoothing portion that removes dents and bends from cards.

The materials of manufacture are not particularly limited. The handle may, for example, be made of wood or plastic. The tubing may be made of rubber, vinyl, or any other ductile and resilient material known in the art.

The dimensions of the dowel and the ductile, resilient tubing are not particularly limited. The dowel may have an overall length comprising a first length and a second length, with the first length being greater than the second length. For example, the first length may be about 6-7 times greater than the second length. The ductile, resilient tubing may have an overall length comprising a third length and a fourth length, with the fourth length being about 0.8 to 1.2 times the third length. The third length may be about equal to the second length and the tubing may surround the first end of the dowel.

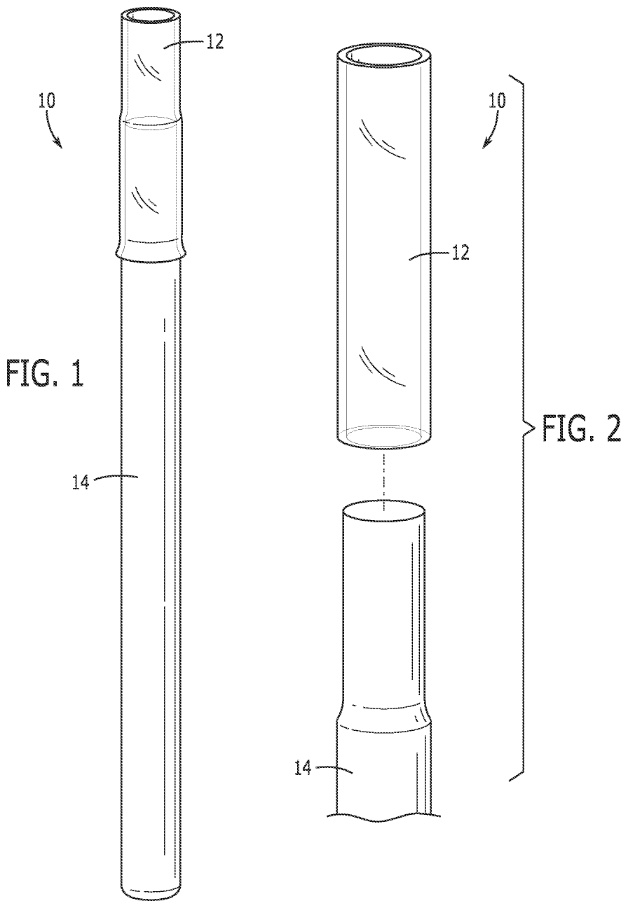

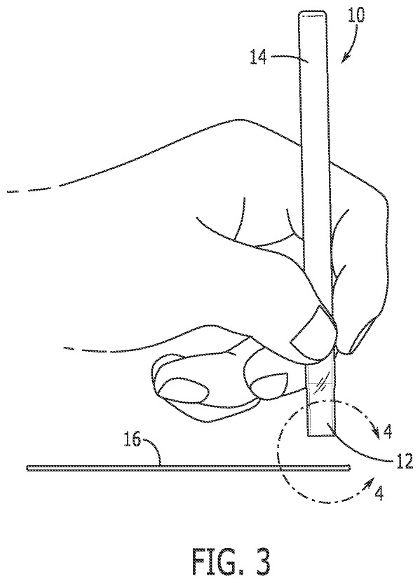

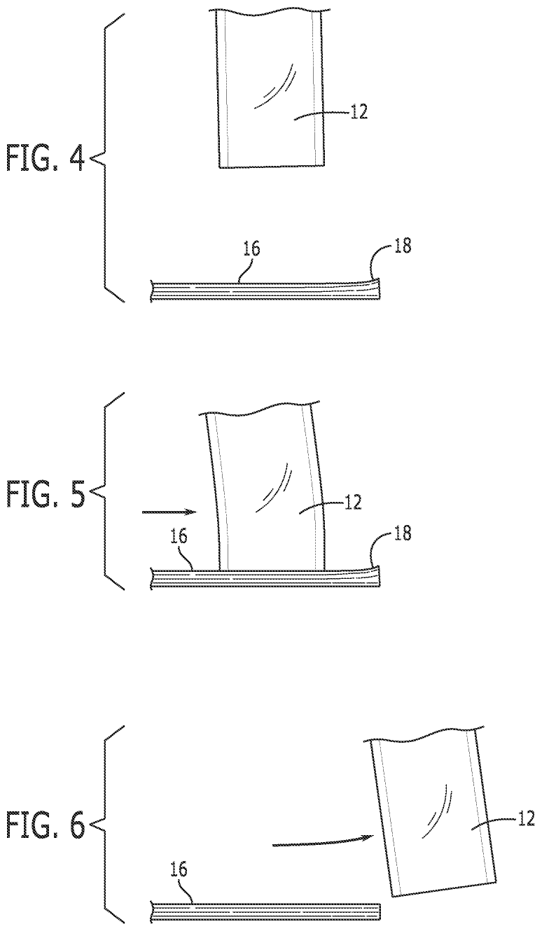

Referring to FIGS. 1 through 6, a collectible card defect correction tool 10 according to an embodiment of the present invention is shown. The tool comprises a cylindrical dowel handle 14 having a length of ductile, resilient tubing 12, shown as transparent in the Figures, coupled to a first end of the handle 14 and extending therefrom. As seen in FIG. 2, a first length of the handle 14 has a first diameter and a shorter second length of the handle 14 has a smaller second diameter. As FIG. 1 shows, the inner diameter of the tubing 12 may be about the same as or slightly smaller than the second diameter. A first portion of the tubing 12 has a length about equal to the handle's second length, while a second portion of the tubing 12 has a length about equal to, slightly less than, or slightly more than the handle's second length, the second portion of tubing 12 extending past the handle 14. The card defect correction tool 10 may be used to correct a dented corner 18 of a collectible card 16, as shown in FIGS. 3-5. The user may hold the tool 10 as he or she would hold a pen or paintbrush. Lowering the tubing 12 end onto the surface of the collectible card 16, the user may slide the tubing 12 across the surface of the card towards and across the defect, smoothing the defect from the surface of the card 16.

It should be understood, of course, that the foregoing relates to exemplary embodiments of the invention and that modifications may be made without departing from the spirit and scope of the invention as set forth in the following claims.

What is claimed is:

1. A collectible card defect correction tool, comprising:
a cylindrical handle having a first diameter over a first length; and
a ductile, resilient tubing coupled to a first end of the cylindrical handle and extending therefrom, the ductile, resilient tubing having an inner diameter.

2. The collectible card defect correction tool of claim 1, wherein the inner diameter is about 5/16″ to 7/16″.

3. The collectible card defect correction tool of claim 1, wherein the cylindrical handle comprises wood.

4. The collectible card defect correction tool of claim 1, wherein the ductile, resilient tubing comprises vinyl or rubber.

5. The collectible card defect correction tool of claim 1, wherein the first end of the cylindrical handle has a second diameter over a second length, and wherein the second diameter is smaller than the first diameter and the inner diameter of the ductile, resilient tubing is about equal to the second diameter.

6. The collectible card defect correction tool of claim 5, wherein the first length of the cylindrical handle is greater than the second length of the first end of the ductile, resilient tubing cylindrical handle.

7. The collectible card defect correction tool of claim 5, wherein the first length is about 6 to about 7 times the second length.

8. The collectible card defect correction tool of claim 5, wherein the second length is about % inch.

9. The collectible card defect correction tool of claim 5, wherein the ductile, resilient tubing has a first portion having third length about equal to the second length and a second portion having fourth length, and wherein the third length of the ductile, resilient tubing surrounds the second length of the cylindrical handle, with the fourth length extending beyond the cylindrical handle.

10. The collectible card defect correction tool of claim 9, wherein the fourth length is about 0.8 to about 1.2 times the third length.

11. A method of correcting a defect in a collectible card comprising:
providing the collectible card defect correction tool of claim 1;
lowering the collectible card defect correction tool such that the ductile, resilient tubing contacts a collectible card surface; and
sliding the collectible card defect correction tool across the defect on the collectible card surface.
